(19) United States
(12) Patent Application Publication
(10) Pub. No.: US 2010/0132033 A1
(43) Pub. Date: May 27, 2010

(54) SERVICE SYSTEM

(75) Inventors: Qianqing Lu, Beijing (CN); Kevin James Jay, Jacksonville, FL (US)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(73) Assignee: GE MEDICAL SYSTEMS GLOBAL TECHNOLOGY COMPANY, LLC, Waukesha, WI (US)

(21) Appl. No.: 12/373,678

(22) PCT Filed: Jul. 13, 2007
(86) PCT No.: PCT/US2007/073436

§ 371 Date: Dec. 7, 2009

(30) Foreign Application Priority Data
Jul. 14, 2006 (CN) 200610106346.5

(51) Int. Cl. G06F 21/00; G06F 15/173; G06K 9/00

(52) U.S. Cl. 726/15; 726/3; 709/223; 382/131

(57) ABSTRACT

A remote service system capable of providing service also in environment of a dynamic IP address is realized. A service demanding apparatus has a demand-side router connected to the Internet by using a dynamic IP address via a broadband line. The demand-side router has authentication obtaining means for obtaining authentication from a service providing apparatus and communication means for performing communication with the service providing apparatus. The service providing apparatus has an authentication server for authenticating the service demanding apparatus and a providing-side router connected to the Internet by using a static IP address. The providing-side router has communication starting means for accessing the demand-side router by using a telephone number on a broadband line to make the demand-side router start performing communication, and communication means for performing communication with the service demanding apparatus.

### CROSS REFERENCE TO RELATED APPLICATIONS

This application claims the benefit of China patent application 200610106346.5 filed Jul. 14, 2006 the contents of which are incorporated herein by reference in their entirety.

### BACKGROUND OF THE INVENTION

The present invention relates to a service system and, more particularly, to a service system in which the Internet is interposed between a service demanding apparatus and a service providing apparatus.

An example of a service system in which the Internet is interposed between a service demanding apparatus and a service providing apparatus is a remote service system of a medical imaging apparatus. In the remote service system, a functional check, trouble shooting, and the like are performed on the medical imaging apparatus such as an MRI (Magnetic Resonance Imaging) apparatus, an X-ray CT (Computed Tomography) apparatus, a radiographic apparatus, or a PET (Positron Emission Tomography) apparatus which is working in a site of a user from a server of a service provider by communications utilizing the Internet (refer to, Patent Document 1).

In the remote service system, the medical imaging apparatus that is working in the user site corresponds to the service demanding apparatus, and the server of the service provider corresponds to the service providing apparatus. Generally, the correspondence between the service providing apparatus and the service demanding apparatuses is 1:n. Since the Internet is used for communications, a global remote service system can be configured.

[Patent Document 1]Japanese Unexamined Patent Publication No. 2003-190105

On the Internet, each service demanding apparatus is identified by an IP (Internet Protocol) address. In environment of a static IP address, an IP address is unique to a user. In contrast, in environment of a dynamic IP address, an IP address is extracted from a group of IP addresses that are pooled in advance and the extracted IP address is used each time access is made, so that an IP address is not unique to a user. Consequently, when a serving demanding apparatus uses a dynamic IP address, the service demanding apparatus cannot be specified with the IP address, so that service cannot be provided.

### SUMMARY OF THE INVENTION

It is desirable that the problem described previously is solved.

One aspect of the invention provides a service system in which the Internet is interposed between a service demanding apparatus and a service providing apparatus, wherein the service demanding apparatus has a demand-side router connected to the Internet by using a dynamic IP address via a broadband line. The demand-side router includes authentication obtaining means for obtaining authentication from the service providing apparatus; and communication means for performing communication with the service providing apparatus. The service providing apparatus includes an authentication server for authenticating the service demanding apparatus; and a providing-side router for performing communication with the service demanding apparatus. The service providing apparatus includes an authentication server for authenticating the service demanding apparatus and a supply-side router connected to the Internet by using a static IP address, and the providing-side router includes communication starting means for accessing the demand-side router by using a telephone number on the broadband line and making the demand-side router start performing communication; and communication means for performing communication with the service demanding apparatus.

It is preferable from the viewpoint of realizing a remote service system for a medical imaging apparatus that the service demanding apparatus demands for service on a medical imaging apparatus, and the service providing apparatus provides service on a medical imaging apparatus.

Preferably, the broadband line is ADSL for the reason that the communication cost is low. Preferably, the communication is cipher communication for the reason that it is difficult for a third party to intercept the communication. Preferably, the cipher communication is VPN communication for the reason that security is high.

According to the invention, a service system is provided in which the Internet is interposed between a service demanding apparatus and a service providing apparatus. The service demanding apparatus has a demand-side router connected to the Internet by using a dynamic IP address via a broadband line. The demand-side router includes authentication obtaining means for obtaining authentication from the service providing apparatus; and communication means for performing communication with the service providing apparatus. The service providing apparatus includes an authentication server for authenticating the service demanding apparatus; and a providing-side router for performing communication with the service demanding apparatus. The providing-side router has communication starting means for accessing the demand-side router by using a telephone number on the broadband line and making the demand-side router start performing communication. Consequently, the service system capable of providing service even in environment of a dynamic IP address can be realized.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the configuration of a service system as an example of the best mode for carrying out the invention.

FIG. 2 is a flowchart of operations of the service system as an example of the best mode for carrying out the invention.

FIG. 3 is a flowchart of operations of the service system as an example of the best mode for carrying out the invention.

### DETAILED DESCRIPTION OF THE INVENTION

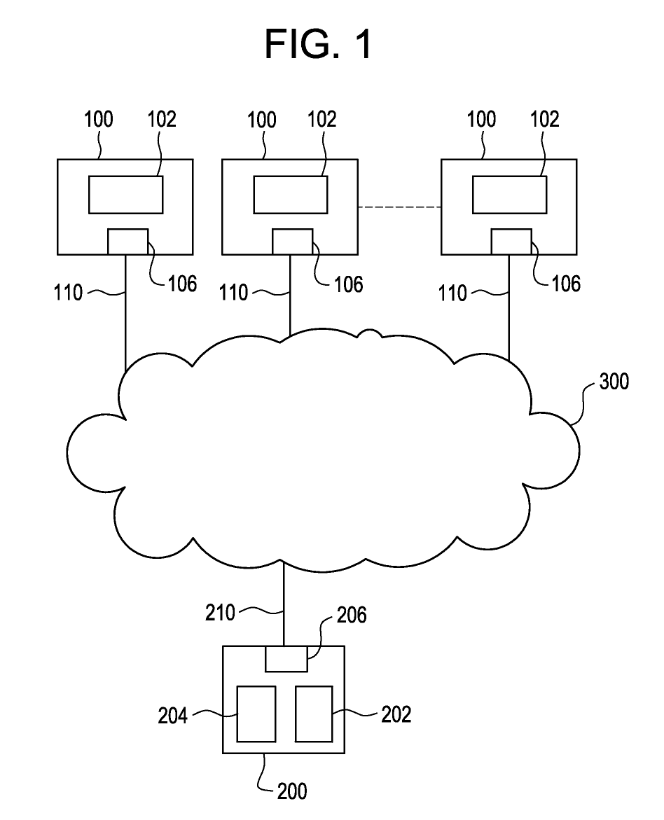

A best mode for carrying out the invention will be described below with reference to the drawings. The present invention is not limited to the best mode for carrying out the invention. FIG. 1 shows a schematic configuration of a service system. The system is an example of the best mode for carrying out the invention. With the configuration of the system, an example of the best mode for carrying out the invention related to the service system is shown.

As shown in FIG. 1, the system is configured by connecting service demanding apparatuses 100 and a service providing apparatus 200 via an Internet 300. The service demanding apparatus 100 is an example of the serving demanding apparatus in the present invention. The service providing apparatus 200 is an example of the service providing apparatus in the invention. The Internet 300 is an example of the Internet in the invention.

The service demanding apparatus 100 is, for example, a medical imaging apparatus such as an MRI apparatus, an X-ray CT apparatus, a radiographic apparatus, or a PET apparatus, and the service providing apparatus 200 is an apparatus for providing various services such as functional check, trouble shooting, and software updating on the medical imaging apparatus.

The service demanding apparatus 100 is not limited to a medical imaging apparatus but may be various devices or facilities in various industrial fields and academic fields demanding for services. The service providing apparatus 200 provides required services to the facilities.

The service demanding apparatus 100 is installed in the location of a user. When a number of users are spread out globally, a plurality of service demanding apparatuses 100 exist globally. The service providing apparatus 200 is installed in the location of a service provider. The service providing apparatus 200 provides services from its location to the service demanding apparatuses 100 all over the world via the Internet 300.

The service demanding apparatus 100 is connected to the Internet 300 via a broadband line 110 using a dynamic IP address. As the broadband line 110, for example, an ADSL (asymmetric digital subscriber line) is used. By using the ADSL, low-cost communication can be performed. The broadband line 110 is an example of the broadband in the invention.

The service demanding apparatus 100 has a service demanding machine 102. The service demanding machine 102 is the main body of service demand. The service demanding machine 102 is connected to the broadband line 110 via a router 106. The router 106 is provided by the service provider. The router 106 is authorized in advance by the service provider. The router 106 is an example of a demand-side router in the invention.

The router 106 has a dynamic IP address. The address is extracted from a group of IP addresses that are preliminarily pooled each time an access is made and is not unique to the service demanding apparatus 100. The router 106 has a telephone number on the broadband line. The telephone number is unique to the service demanding apparatus 100.

The service providing apparatus 200 is connected to the Internet 300 by a static IP address via a broadband line 210. As the broadband line 210, for example, FTTH (fiber to the home) or the like is used. The broadband line 210 is not limited to FTTH but may be ADSL.

The service providing apparatus 200 has a service providing machine 202. The service providing machine 202 is the main body of service provision and is constructed by a server for providing service or the like. The service providing apparatus 200 also includes an authentication machine 204. The authentication machine 204 authenticates validity of service demand from the service demanding apparatus 100 and is constructed by a server for authentication or the like. The authentication machine 204 is an example of an authentication server in the invention.

The service providing machine 202 and the authentication machine 204 are connected to the broadband line 210 via a router 206. The router 206 has a static IP address. The address is unique to the service providing apparatus 200. The router 206 is an example of a providing-side router in the invention.

The operation of the system will be described. There are two operation modes; a push mode in which the service providing apparatus 200 side takes action first, and a pull mode in which the service demanding apparatus 100 side takes action first.

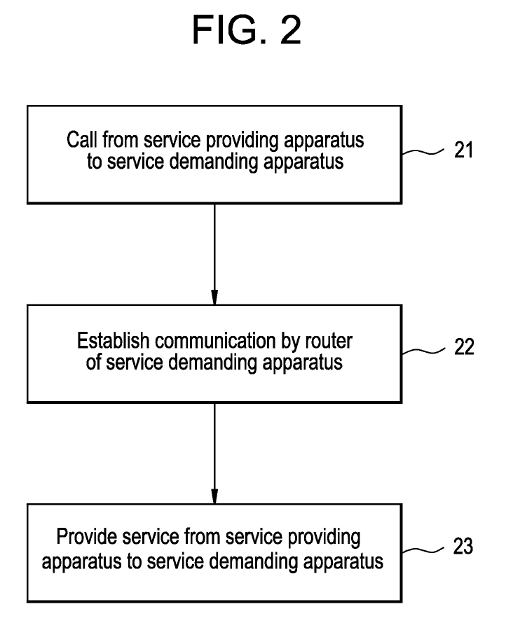

FIG. 2 shows a flow chart of operations in the push mode. As shown in FIG. 2, in step 21, the service providing apparatus 200 makes a call to a predetermined service demanding apparatus 100. A telephone call is made from the router 206 of the service providing apparatus 200 to the router 106 of the predetermined service demanding apparatus 100.

Since the telephone number is unique to the service demanding apparatus 100, by making a call to the number, the service demanding apparatus 100 intended by the service side can be accessed with reliability. That is, even the user of a dynamic IP address can accurately use on-demand push service from the service providing side.

Since a dynamic IP address is sufficient, service can be provided also to a user in an area in which a static IP address cannot be used or is difficult to be used, so that customer coverage is widened.

The router 106 of the service demanding apparatus 100 that has received the call establishes communication with the service providing apparatus 200 in step 22. Cipher communication is used as the communication. The cipher communication makes interception of a third party difficult. As the cipher communication, for example, VPN (Virtual Private Network) is used. By the VPN, high levels of security are maintained.

By utilizing the established VPN, in step 23, the service providing apparatus 200 provides services to the service demanding apparatus 100. The service is provided by the service providing machine 202.

The router 206 that makes a call in step 21 and makes the router 106 establish communication in step 22 is an example of communication starting means in the invention. The router 206 performing communications with the service demanding apparatus 100 in step 23 is an example of communication means in the invention.

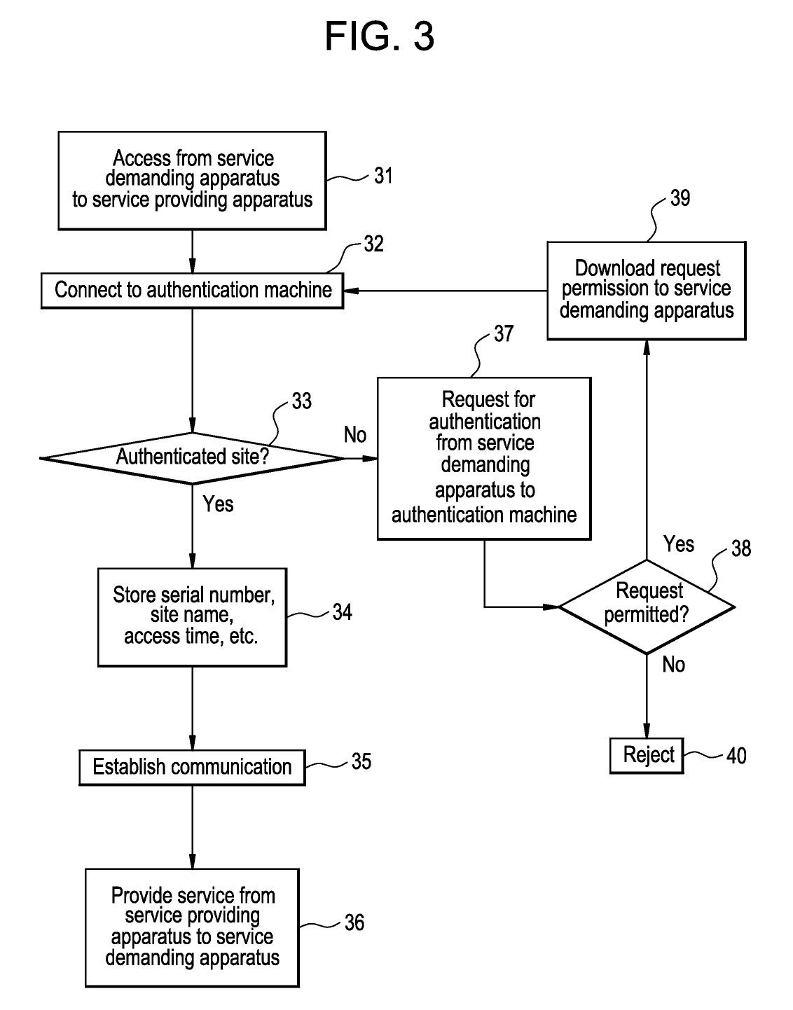

FIG. 3 shows a flow chart of operations in the pull mode. As shown in FIG. 3, the service demanding apparatus 100 accesses the service providing apparatus 200 in step 31. Specifically, the router 106 in the service demanding apparatus 100 accesses the router 206 in the service providing apparatus 200.

The service demanding apparatus 100 accesses the service providing apparatus 200 by using a static IP address. Since the static IP address is unique to the service providing apparatus 200, the access to the service providing apparatus 200 is made accurately.

The router 106 is connected to the authentication machine 204 in the service providing apparatus 200 in step 32. The authentication machine 204 determines whether the service demanding apparatus 100 is a site that has been preliminarily authenticated or not in step 33.

When it is determined that the service demanding apparatus 100 is an authenticated site, the router 206 stores predetermined information such as serial number, site name, access time, and the like in step 34 and establishes communication to the service demanding apparatus 100 in step 35. As the communication, cipher communication is used. The cipher communication is, for example, VPN.

By using the established VPN, the service demanding machine 102 receives the service provided by the service providing machine 202 in step 36. The router 106 performing communication with the service providing apparatus 200 in step 36 is an example of communication means in the invention.

When it is determined in step 33 that the service demanding apparatus 100 has not been authenticated yet, the router 106 of the service demanding apparatus requests the authentication machine 204 to perform authentication in step 37. The router 106 making the request for authentication in step 37 is an example of authentication obtaining means in the invention.

On the basis of the request, in step 38, the authentication machine 204 examines whether the request is to be permitted or not. When the request is permitted, in step 39, the request permission is downloaded to the router 106 of the service demanding apparatus.

Consequently, when the router 106 is connected again to the authentication machine 204 in step 32, based on the determination of the authentication machine 204 in step 33, service provision can be received. When the authentication machine 204 determines in step 38 that the request is not permitted, the request is rejected in step 40.

Many widely different embodiments of the invention may be configured without departing from the spirit and the scope of the present invention. It should be understood that the present invention is not limited to the specific embodiments described in the specification, except as defined in the appended claims.

1. A service system comprising:
a service demanding apparatus and a service providing apparatus arranged such that an Internet is interposed therebetween, said service demanding apparatus comprises a demand-side router connected to the Internet using a dynamic IP address via a broadband line, said demand-side rooter comprising:
an authentication obtaining device configured to obtain authentication from said service providing apparatus; and
a communication device configured to perform communication with said service providing apparatus, said service providing apparatus has comprising:
an authentication server configured to authenticate said service demanding apparatus; and
a providing-side router connected to the Internet using a static IP address, said providing-side router comprising:
a communication starting device configured to access said demand-side router using a telephone number on the broadband line and to make said demand-side router start performing communication; and
a communication device configured to perform communication with said service demanding apparatus.

2. The service system according to claim 1, wherein said service providing apparatus is configured to initiate communication using a push mode.

3. The service system according to claim 1, wherein said service demanding apparatus is configured to initiate communication.

4. The service system according to claim 1, wherein the telephone number that said communication starting device uses is unique to said service demanding apparatus.

5. The service system according to claim 1, wherein the static IP address that said providing-side router uses is unique to said service providing apparatus.

6. The service system according to claim 1, wherein said providing-side router is configured to store predetermined information, when it is determined that said service demanding apparatus is an authenticated site.

7. The service system according to claim 6, wherein the predetermined information includes one of a serial number, a site name, and an access time.

8. The service system according to claim 1, wherein said demand-side router is configured to request said authentication server to perform authentication, when it is determined that said service demanding apparatus has not been authenticated yet.

9. The service system according to claim 8, wherein demand-side router is configured to download the request to perform authentication, when said authentication sever permits the request for the authentication.

10. The service system according to claim 1, wherein said service providing apparatus is configured to provide a service that is one of a functional check, trouble shooting, and software updating.

11. The service system according to claim 1, wherein said service demanding apparatus is configured to demand service of a medical imaging apparatus, and said service providing apparatus is configured to provide service on the medical imaging apparatus.

12. The service system according to claim 11, wherein the medical imaging apparatus is a Magnetic Resonance Imaging apparatus.

13. The service system according to claim 11, wherein the medical imaging apparatus is an X-ray CT apparatus.

14. The service system according to claim 11, wherein the medical imaging apparatus is a radiographic apparatus.

15. The service system according to claim 11, wherein the medical imaging apparatus is a Positron Emission Tomography apparatus.

16. The service system according to claim 4, wherein said service demanding apparatus is configured to demand service of a medical imaging apparatus, and said service providing apparatus is configured to provide service on the medical imaging apparatus.

17. The service system according to claim 16, wherein the medical imaging apparatus is a Magnetic Resonance Imaging apparatus.

18. The service system according to claim 1, wherein the broadband line is ADSL.

19. The service system according to claim 1, wherein the communication is cipher communication.

20. The service system according to claim 19, wherein the cipher communication is VPN communication.
